(19) United States
(12) Patent Application Publication
(10) Pub. No.: US 2015/0255948 A1
(43) Pub. Date: Sep. 10, 2015

(54) LASER EXCITATION PULSING SYSTEM

(71) Applicant: PAR SYSTEMS (PTY) LTD., Pretoria (ZA)

(72) Inventors: Hubertus VON BERGMANN, Somerset West (ZA); Timo STEHMANN, Stellenbosch (ZA)

(73) Assignee: PAR SYSTEMS (PTY) LTD., Pretoria (ZA)

(21) Appl. No.: 14/718,401

(22) Filed: May 21, 2015

Related U.S. Application Data
(63) Continuation of application No. PCT/IB2013/060397, filed on Nov. 26, 2013.

(30) Foreign Application Priority Data
Nov. 28, 2012 (ZA) 2012/08998

(51) Int. Cl. H01S 3/0975; H01F 30/16; H01S 3/097

(52) U.S. Cl. CPC H01S 3/0975; H01S 3/09702; H01F 30/16

(57) ABSTRACT

A laser excitation pulsing system is provided. The system includes a pulse transformer having a plurality of parallel connected primary windings and a secondary winding wound around a toroidal magnetic core in a coaxial fashion in which at least part of the primary windings are in the form of tubular sections through which corresponding parts of the secondary winding extend.

### TECHNICAL FIELD

This disclosure relates to laser technology. More specifically the disclosure relates to a laser excitation pulsing system and to a laser.

### BACKGROUND

The discussion below is merely provided for general background information and is not intended to be used as an aid in determining the scope of the claimed subject matter.

Conventional laser excitation systems employed for high pressure gas lasers, and in particular for Transversely Excited Atmospheric pressure (TEA) carbon dioxide (CO₂) lasers, use spark gaps or thyratrons as switching elements which can directly switch high voltages of several tens of kilovolts required for these lasers and which can provide voltage pulses with rise times of the order of 100 ns at electrodes of the laser which are necessary to generate stable, homogeneous volume discharges in a laser gas medium. Spark gaps can generally only be operated at relatively low repetition rates and are therefore only employed in low power, low repetition rate applications.

Thyratrons are suitable for high power, high repetition rate applications; however, they have restricted availability, are expensive, and have limited service life, which results in high operational costs. Thyratrons also suffer from frequent failures, which reduce long term system reliability which is paramount in industrial applications. Lifetimes of thyratrons, and with it system reliability, can be improved to some extent by using magnetic pulse compression techniques which, to some degree, alleviate the harsh operating conditions for the thyratrons. Operational costs of laser systems employing these techniques are, however, still dominated by the costs for thyratron replacements.

Thyratrons can be eliminated altogether by using solid-state or semiconductor switching elements, such as thyristors, gate turn-off thyristors (GTO), metal-oxide semiconductor field-effect transistors (MOSFET), or insulated-gate bipolar transistors (IGBT). These devices are relatively low in cost and have, if used within their specifications, extremely long (and practically unlimited) lifetimes. The devices are, however, generally limited in respect of their maximum operating voltage and current rise time, which are of the order of only a few kV and kA/μs, respectively. These values are far from those required for direct switching and which can be obtained from thyratrons. Solid-state switches can therefore only be used in combination with (1) voltage step-up/pulse transformers which raise the voltage from the safe operation level of the switch to the required high circuit voltage and (2) pulse compression circuits which compress the pulse time from one that can be handled by the switch to that needed for the generation of a stable discharge.

While circuits based on solid-state switches do perform satisfactorily and are today used in many commercial excimer and TEA CO₂ laser systems, they tend to employ large volumes of magnetic materials for transformer and compression circuit cores, which increases the volume, weight, and cost of the systems. These systems tend to be relatively complex and as a result tend to suffer from reliability issues. There are a number of different circuit topologies and different types of solid-state switches that can be chosen, as well as different design optimisation strategies, making the circuit design a highly complex task.

In addition, the choice of a particular configuration depends on the laser specifications, such as pulse energy, peak voltage, and voltage pulse rise time that have to be delivered by the excitation system. A limiting component in the design of a laser excitation system is the solid state switch, since it limits an input voltage and current pulse duration of a primary transfer loop which in turn dictates the required voltage gain and compression ratio of the circuit necessary to achieve the required circuit output specifications.

A second limiting component is the voltage pulse transformer, which, because of the leakage inductance it introduces into the circuit, strongly influences the transfer time of a respective current loop and therefore dictates which circuit topology can be employed. Low inductance pulse transformer design is complicated if high step-up ratios are required and is a highly skilled task. However, if a pulse transformer with a high step-up ratio and low leakage inductance could be realized, the design would produce a highly efficient, compact laser excitation pulsing system.

Therefore, it would be advantageous to provide a solution which overcomes the shortcomings of the prior art.

### SUMMARY

This Summary and the Abstract herein are provided to introduce a selection of concepts in a simplified form that are further described below in the Detailed Description. This Summary and the Abstract are not intended to identify key features or essential features of the claimed subject matter, nor are they intended to be used as an aid in determining the scope of the claimed subject matter. The claimed subject matter is not limited to implementations that solve any or all disadvantages noted in the Background.

According to a first aspect of the disclosed embodiments, there is provided a laser excitation pulsing system, which includes a pulse transformer having a plurality of parallel connected primary windings and a secondary winding wound around a toroidal magnetic core in a coaxial fashion in which at least part of the primary windings are in the form of tubular sections through which corresponding parts of the secondary winding extend.

The laser excitation pulsing system may be for an excimer laser or a Transversely Excited Atmospheric pressure (TEA) carbon dioxide (CO₂) laser.

The tubular sections of the primary winding may include inner tubular parts and outer tubular parts and the inner tubular parts may be parallel spaced and circularly arranged about a central region.

The outer tubular parts of the tubular sections of the primary winding may be parallel spaced and may be radially arranged around the inner parts thereof.

The toroidal magnetic core may be located between the inner and outer parts of the tubular sections of the primary winding.

A part of any one or both of the primary winding and secondary winding of the pulse transformer may be implemented on a printed circuit board (PCB).

The laser excitation pulsing system may include a switching arrangement having a solid-state switch connected to a primary winding of the pulse transformer.

The solid-state switch may be any one of a thyristor, a metal-oxide-semiconductor field effect transistor and an insulated-gate bipolar transistor switch. In an embodiment in which the solid-state switch is a thyristor, the thyristor may be a gate turn-off thyristor.

The switch may be configured to be operable at a voltage of between 1 kV and 6.5 kV (both values inclusive). More specifically, the switch may be configured to be operable at a voltage of between 2 kV and 3.3 kV (both values inclusive).

The switch may be configured to have a current transfer time of less than 10 μs. More specifically, the switch may be configured to have a current transfer time of less than 6.9 μs or 7 μs. The switching arrangement may include a single switch.

The laser excitation pulsing system may include an LC circuit, arranged in an LC inversion topology, which may be connected between the switch and the pulse transformer.

The system may include at least one magnetic pulse compression stage connected to the pulse transformer.

A first of the at least one magnetic pulse compression stage may be connected between the switch and the primary winding of the pulse transformer. In particular, the first magnetic pulse compression stage may be connected between the LC inversion circuit and the primary winding of the pulse transformer.

The laser excitation pulsing system may include a second compression stage and the second compression stage may be connected to the secondary winding of the pulse transformer.

The second compression stage may be connected between a secondary winding of the pulse transformer and a discharge gap of a laser.

The pulse transformer and the two magnetic compression stages may each include a reset winding. The reset winding may be in the form of a single turn winding which is configured to provide a reset signal for a magnetic core around which the winding is provided.

The reset windings may be connected in series with each other and may be driven by a single reset power supply.

According to another aspect of the disclosed embodiments, there is provided a laser, which includes a laser excitation pulsing system as described.

The disclosed embodiments will now be described, by way of example, with reference to the accompanying diagrammatic drawings.

### BRIEF DESCRIPTION OF THE DRAWINGS

In the drawings:

FIG. 1 shows a schematic circuit layout of a laser excitation pulsing system in accordance with an aspect of the invention;

FIG. 2 shows a schematic layout of a pulse transformer of the laser excitation pulsing system of FIG. 1, where the arrows indicate the current flow through a primary winding of the pulse transformer;

FIG. 3 shows a schematic layout of the pulse transformer of FIG. 2, where the arrows indicate the current flow through a secondary winding of the pulse transformer;

FIG. 4 shows a schematic sectional illustration of the pulse transformer of FIG. 2;

FIG. 5 shows a three-dimensional view of an alternative embodiment of the pulse transformer of FIG. 2;

FIG. 6 shows a three-dimensional sectional view of the pulse transformer of FIG. 5;

FIG. 7 shows a sectional view of part of the laser excitation pulsing system of FIG. 1;

FIG. 8 shows a three-dimensional view of part of the laser excitation pulsing system of FIG. 1; and

FIG. 9 shows a graphical illustration of voltage and current traces which were measured during the operation of the laser excitation pulsing system.

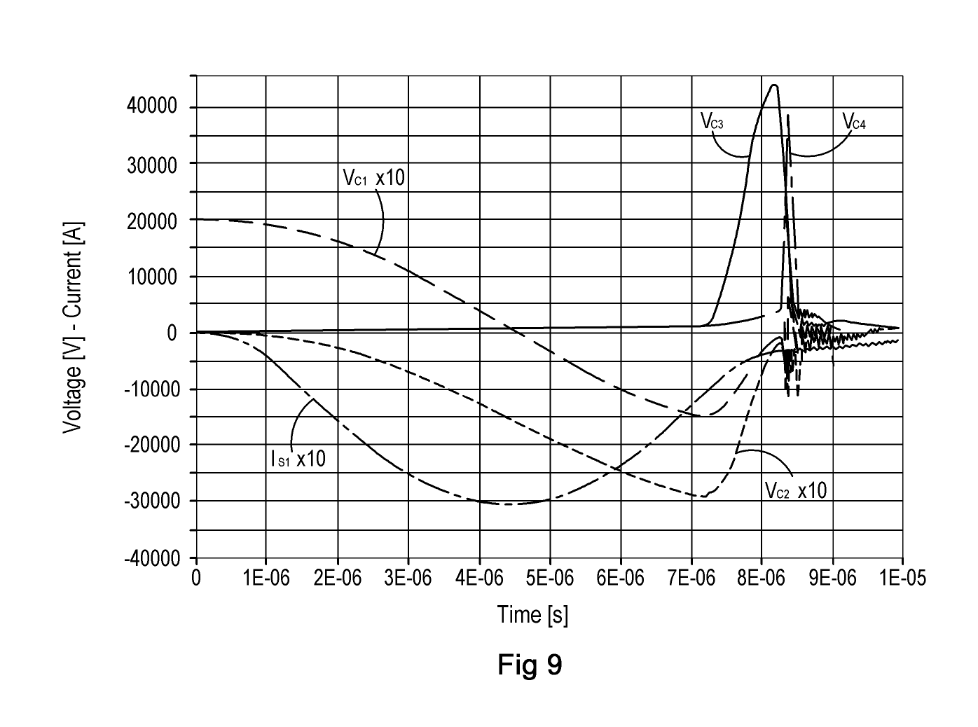

### DETAILED DESCRIPTION

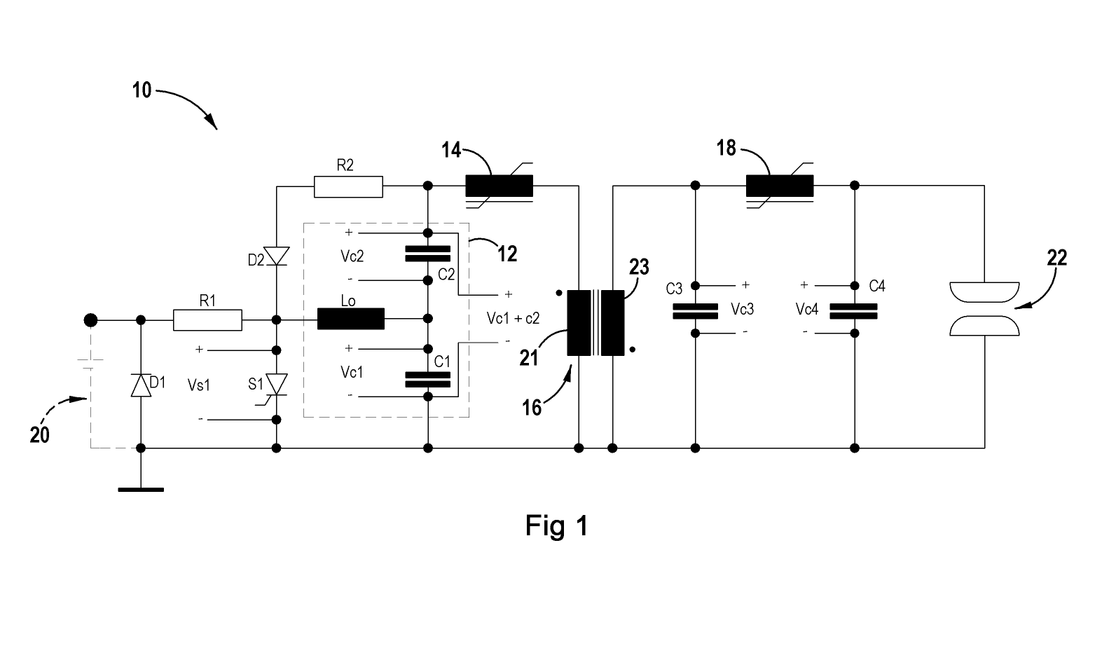

In the drawings, reference numeral 10 refers generally to a laser excitation pulsing system in accordance with an aspect of the disclosed embodiments. More specifically, the system 10, in this example, is a high voltage, high repetition rate pulsing system which can be used for the excitation of an excimer laser or a TEA CO2 laser. The circuit layout of the system 10 is illustrated in FIG. 1.

In this example, the desired output specifications for the system 10 are: a peak pulse voltage of about 44 kV; a voltage rise time of less than 120 ns; a pulse output energy of about 13 J, and a pulse rate of up to about 600 Hz. It should be understood that these specifications are only for one exemplary embodiment. Other systems having aspects of the present disclosure may have different output specifications. In addition, although the component values are provided, they are merely exemplary and that the values might change to obtain other desired operating characteristics of the system.

The system 10 includes a switch S₁, an LC inversion circuit/topology 12, a first magnetic pulse compression stage 14 (5 turns, 1×Finemet 210×102×25 mm), a pulse transformer 16 and a second magnetic pulse compression stage 18 (4 turns, 2×Finemet 210×102×25 mm). The switch S₁ is in the form of an IGBT which is rated for 3.3 kV and a DC current of 1.5 kA. Due to the relatively short pulses which will be generated by the system 10, these parameters of the switch S₁ can however be increased, relatively safely, by factors of 2 to 3. One of the advantages of using an IGBT rather than a more conventional thyristor, is that an IGBT can be actively switched off, which leads to more reliable operation of the system 10. By using a single switch S₁, rather than the often employed series connection of multiple switches, it leads to a reduction in circuit complexity of the system 10 and may increase its reliability as well. The switch S₁ is operated at a voltage of 2.0 kV and a current transfer time of 6.9 μs, which results in a peak current of 3.3 kA.

The LC inversion circuit/topology 12 is connected to the switch S₁ as shown in FIG. 1. The LC inversion circuit 12 consists of two storage capacitors C₁ and C₂ and an inversion inductor L₀ (3 turns, 100 mm diameter×55 mm long) and is configured to induce a voltage V_{C1+C2} across the capacitors C₁ and C₂ that is double the voltage V_{S1} across the switch S₁ (when the switch S₁ is open). The LC inversion circuit 12 therefore increases the 2 kV across the switch S₁ to 4 kV, which reduces the required voltage step-up ratio of the pulse transformer 16 that is needed to produce the desired peak pulse voltage. The values of capacitors C₁ and C₂ are 3.74 μF and 3.30 μF respectively.

The main aim of the two pulse compression stages 14 and 18 is to compress the pulse which is initially generated by the switch S₁ in order to lower the rise time of the pulse and proportionally increase the peak current in order to meet the output specifications.

The specific design of the pulse transformer 16, which is discussed in more detail below, results in a relatively low inductance, which means that the pulse transformer 16 can be inserted after the first compression stage 14. As a result, the first pulse compression stage 14 operates at a lower voltage (as it is positioned before the pulse transformer 16), which significantly improves the efficiency of the first compression stage 14 and results in a high compression ratio. The lower operating voltage also allows the first compression stage 14 to operate with a smaller magnetic core. The lower operating voltage therefore reduces the required volume of the magnetic core of the first compression stage 14. Since the first compression stage 14 reduces the pulse time, it results in the pulse transformer 16 requiring a magnetic core which has a reduced cross-section and which is smaller in volume.

One of the advantages of inserting the pulse transformer 16 after the first compression stage 14 is that the pulse transformer 16 requires shorter hold-off times and therefore requires a smaller magnetic core (i.e. reducing the required volume of the magnetic core of the pulse transformer 16). However, due to the reduced pulse time, the pulse transformer 16 requires a low leakage inductance design. In order to reduce the leakage inductance, parts of a transformer winding of the pulse transformer 16 resemble a coaxial transmission line transformer.

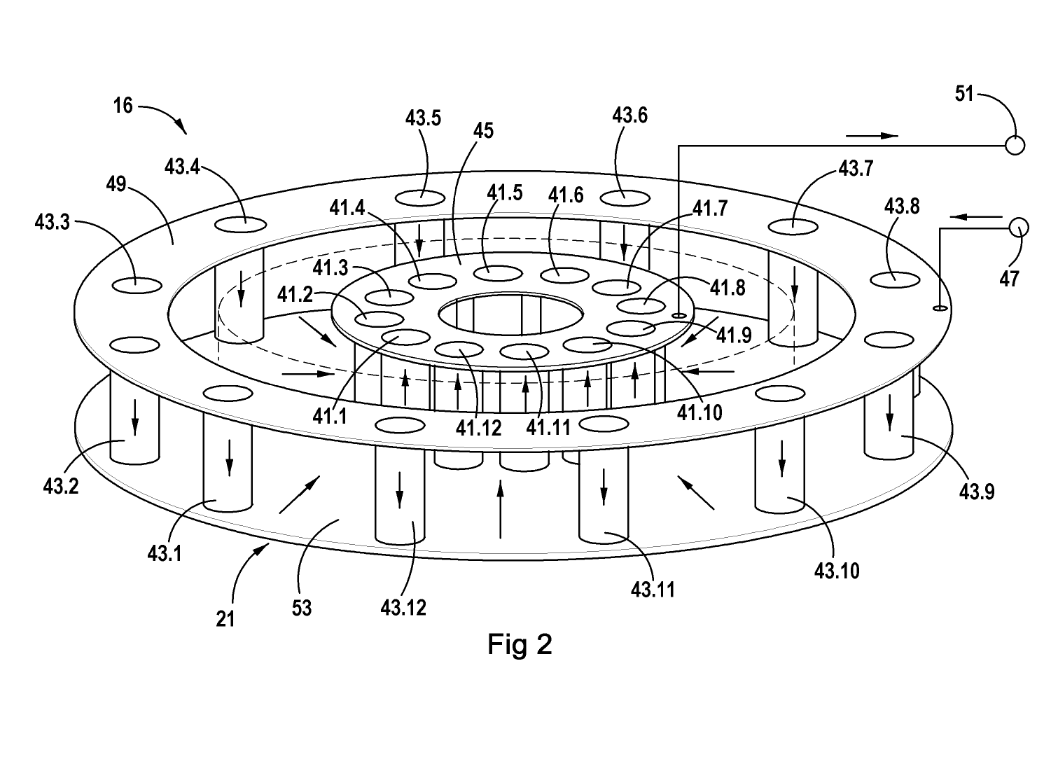

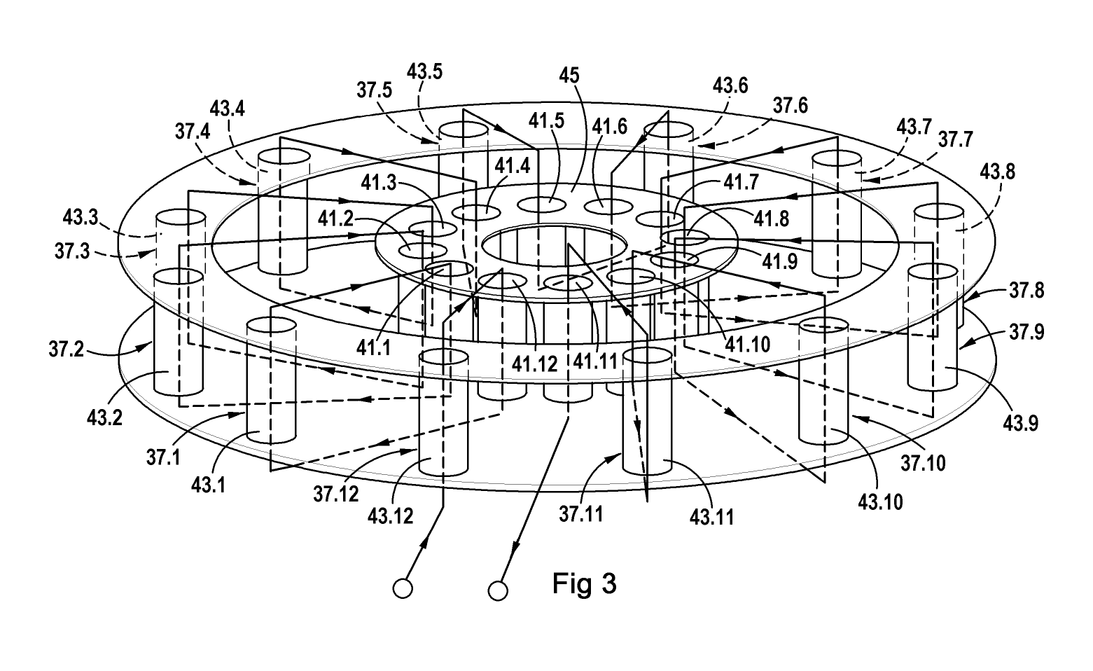

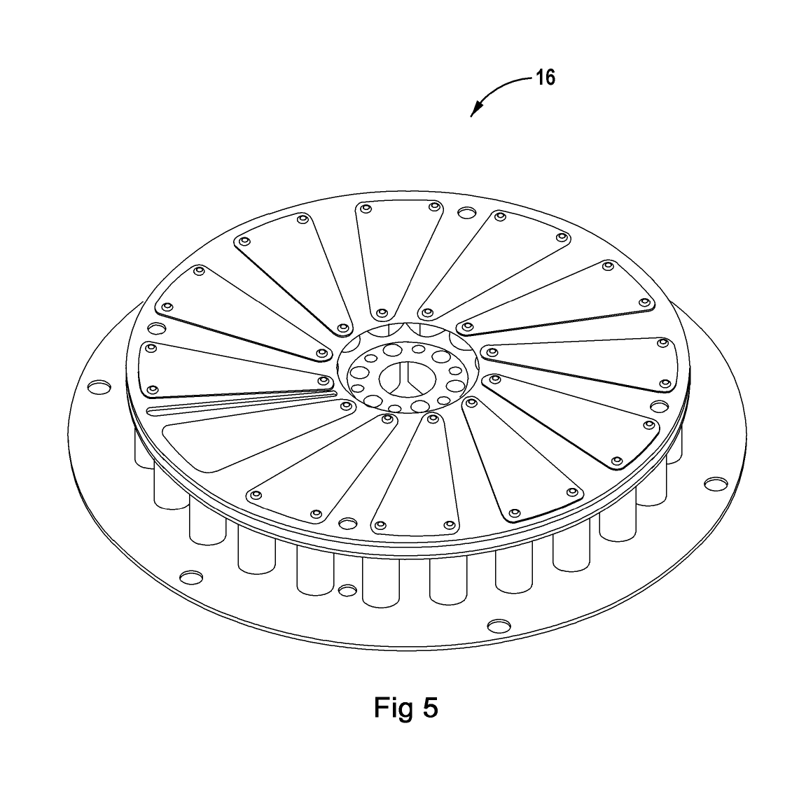

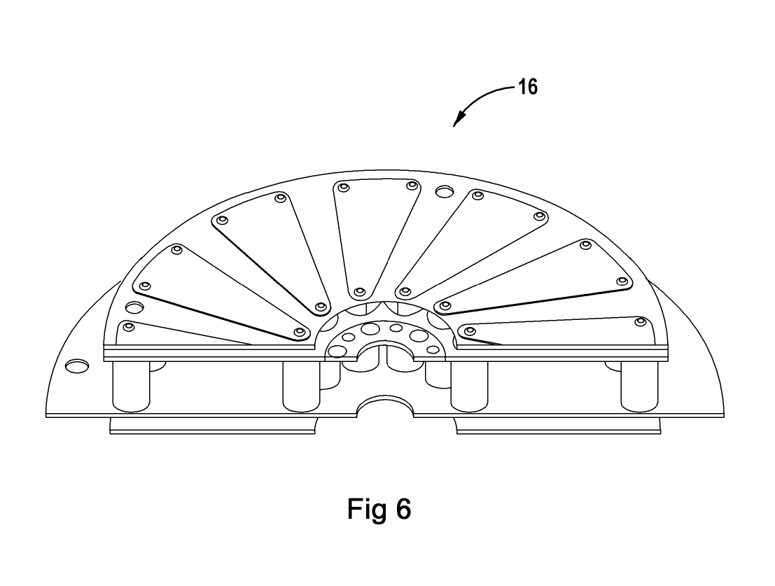

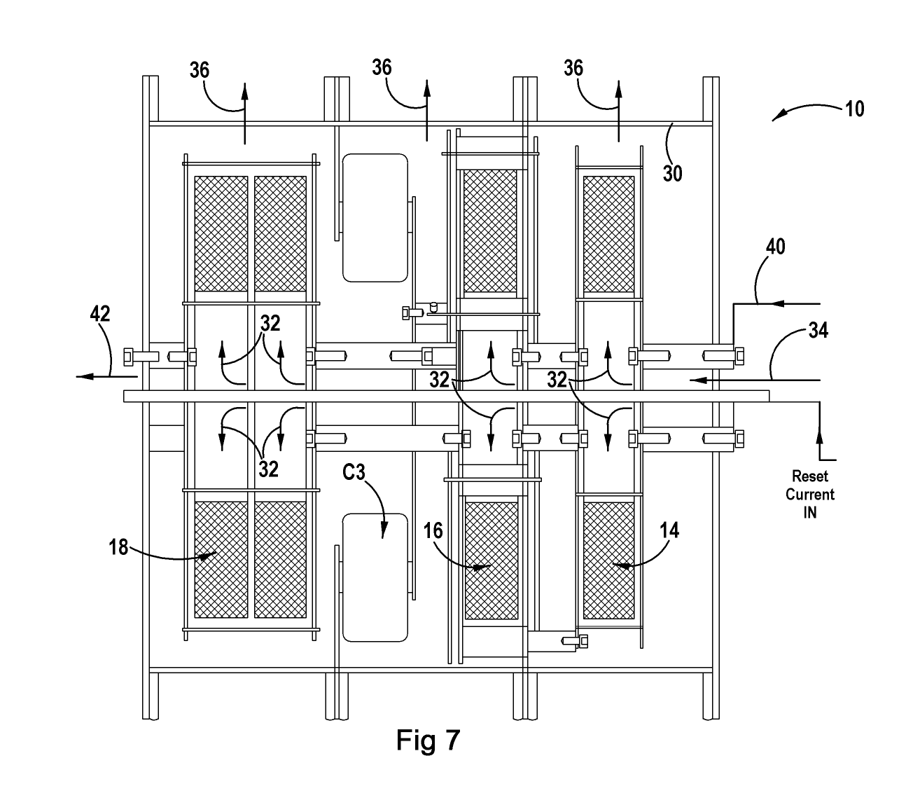

A winding configuration of the pulse transformer 16 is shown schematically in FIGS. 2-4 (see also FIGS. 5-7 which illustrate the pulse transformer 16). The winding configuration includes a primary winding 21 (see FIG. 2) and a secondary winding 23 (see FIG. 3). The primary winding 21 is a single turn primary winding and has 12 parallel connected sections 37.1-37.12 which extend around a ring-shaped magnetic core 52. The secondary winding 23 includes 12 series-connected turns which extend along the parallel-connected sections 37.1-37.12 of the primary winding 21, thereby resulting in a 12 turn step-up ratio. More specifically, the sections 37.1-37.12 include 12 inner tubular parts 41.1-41.12 which are circumferentially spaced about a centre point, and 12 outer tubular parts 43.1-43.12 which are circumferentially spaced about the inner parts 41.1-41.12. The ring-shaped magnetic core 52 is located/positioned between the inner and outer parts 41 and 43. Upper ends of the inner parts 41.1-41.12 are connected to each other by means of a plate member 45 to which an output 51 of the pulse transformer 16 is connected. Similarly, upper ends of the outer parts 43.1-43.12 are connected to each other by means of a plate member 49 to which an input 47 of the pulse transformer 16 is connected. Lower ends of the inner and outer parts 41 and 43 are connected to each other by means of a plate 53.

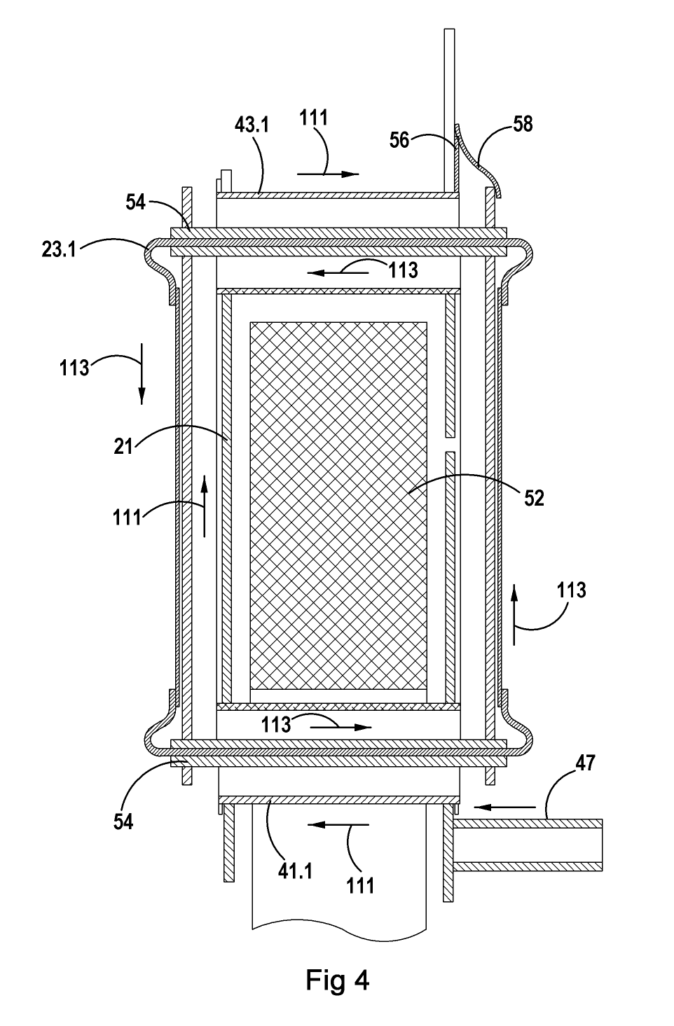

The arrows in FIGS. 2 and 3 illustrate the current flow through the primary winding 21 and secondary winding 23, respectively. The secondary winding 23 extends through the tubular parts 41 and 43 in a coaxial fashion. In order to reduce inductance, the number of outer tubular parts 43 of the primary winding 21 can be increased (see FIGS. 5-7), e.g. to 24 parts in total. In this case, the secondary winding 23 will extend through only some of the outer parts 43, i.e. through 12 outer parts 43 in total. In order to simplify the construction, the transformer 16 utilizes separate printed circuit boards (PCBs) for each of the primary and secondary windings 21 and 23, respectively, which ensure sufficient high-voltage insulation. The magnetic core 52 has the same dimensions as the magnetic core of the first compression stage 14, as well as a magnetic core of the second compression stage 18. The primary and secondary windings 21 and 23 are grounded by means of a primary and a secondary ground 56 and 58, respectively (see FIG. 4). The arrows 111 and 113 in FIG. 4 refer to the current flow through the primary and secondary windings 21 and 23 respectively. A Teflon insulating sleeve 54 (see FIG. 4) is fitted around portions of the secondary winding 23.1, which extend through the tubular inner and outer parts 41 and 43.

Through computational electromagnetic (CEM) simulations it has been found that this approach reduces the leakage inductance by a factor of between 5 and 10, which indicates that a high level of field confinement is achieved. The pulse transformer 16 design described above has a comparatively small leakage inductance, provides sufficient high-voltage insulation, and has a relatively simple construction.

The second pulse compression stage 18 is able to compress the output current pulse duration to 150 ns, which corresponds to a voltage rise time (10%-90%) of less than 100 ns. The first and second compression circuits 14 and 18 are designed using printed circuit boards (PCBs) with a cage type arrangement of conductors. A reset for the magnetic cores of the two compression stages 14 and 18 and the pulse transformer 16 is provided by a single turn winding for each of these components. The windings are connected in series and therefore require only a single reset power supply.

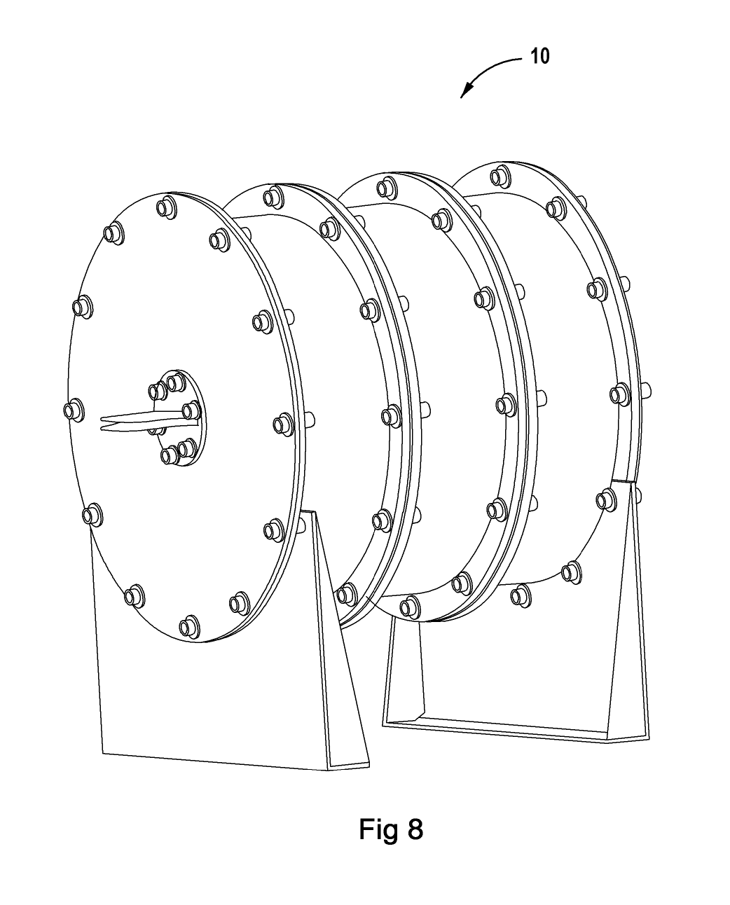

The whole system 10 is placed in insulating transformer oil in order to provide high voltage insulation, and which is circulated through the system 10 for cooling of the various components of the system 10 (see FIG. 8). Arrows 32, 34, and 36 illustrate how the oil enters the system (see arrow 34), is distributed (see arrows 32) and exits the system (see arrows 36). Reference numeral 30 refers to a cylindrical mounting tube for the compressor 10. The mounting tube 30 is slotted in order to allow oil and air to escape from the system 10. Arrow 40 refers to an input of the first compressor stage 14, and arrow 42 refers to an output of the system 10, which leads to a laser which is connected to the system 10.

The operation of the circuit will now be explained with reference to FIG. 1. A switched mode power supply 20 is used to charge the storage capacitors C₁ and C₂ initially, through resistor R₁ and inversion inductor L₀, to an operating voltage V_{O} (i.e. |V_{C1}|=|V_{C2}|=V_{O}). During the initial charging of the capacitors C₁ and C₂, switch S₁ is open. A ground return path for the charging of C₂ extends through the first pulse compressor 14 and the primary winding 21 of the pulse transformer 16. Resistor R₁ (10 Ω-500 W) and diode D₁ (4×1200V-900 A (2×DSEI 2×101) serve to protect the power/charge supply against voltage reversal and over currents.

Initially, capacitors C₁ and C₂ are charged to opposite voltages, which result in a combined voltage V_{C1+C2} of zero across the first compression stage 14 and the primary winding 21 of the pulse transformer 16. When the switch S₁ is closed, a current is allowed to flow in the loop consisting of the switch S₁, the inductor L₀, and the capacitor C₁ which will in time invert the voltage across C₁, which results in a combined voltage of −2×V_{O} across the first compression stage 14 and the primary winding 21 of the pulse transformer 16 (V_{C1+C2}), thereby effectively doubling the initial charging voltage.

The first compression stage 14 is designed/configured to saturate at the time maximum voltage is reached across the two capacitors C₁ and C₂ (V_{C1+C2}), which results in the first compression stage 14 switching to a low inductance state and thereby allowing resonant energy transfer from the two capacitors C₁ and C₂ through the primary and secondary windings 21 and 23 of the pulse compressor 18 to a capacitor C₃. The energy transfer time is determined by the combined saturated inductance of the first compression circuit 14 and the leakage inductance of the pulse transformer 16. The voltage V_{C3} across capacitor C₃ is increased from 2×V_{O} by the step-up ratio of the pulse transformer 16 to a value slightly higher than the required output voltage of the system 10 (i.e. slightly higher than 44 kV).

The second compression stage 18, in turn, is designed/configured to saturate at the time when the charge transfer to capacitor C₃ has been completed and the voltage across capacitor C₃ (V_{C3}) has reached its maximum value. When the second compression stage 18 saturates, another energy transfer then takes place where the charge in capacitor C₃ is transferred to a capacitor C₄, which is connected in parallel to a discharge gap 22 of a laser. Once the voltage across capacitor C₄ (V_{C4}) has reached the breakdown voltage of the discharge gap 22, a glow discharge is initiated in a laser gas of the laser and energy is transferred from C₄ to the discharge gap 22. The values of capacitors C₃ and C₄ are 13.60 nF and 13.02 nF respectively.

Additional required circuit components ensuring automatic pre-ionisation of the gas volume prior to breakdown are generally well known and will therefore not be discussed in greater detail.

In any practical laser excitation system it will not be possible to exactly match impedances of the discharge gap 22 from capacitor C₄, through stray circuit inductance (not specifically illustrated), to the discharge gap 22. This results in incomplete energy transfer and energy being reflected back into the system 10. Associated voltages will therefore be transmitted through the system 10 in reverse direction and can lead to large voltage oscillations across the two capacitors (V_{C1+C2}) and across the switch S₁ (V_{S1}). This can be detrimental to the operation of the switch S₁ and could in severe cases lead to damage.

In order to address this issue, a so-called snubber circuit is provided which consists of a snubber resistor R₂ (10 Ω-500 W) and reverse diode D₂ (4×1200V-900 A (2×DSEI 2×101), which will damp out voltage oscillations on an input side of the system 10 in order to provide for the safe switching off of the switch S₁ and allowing high repetition rate operation of the system 10. In a practical experiment, the system 10 was constructed and various voltage and current traces were measured. FIG. 10 sets out these measurements (I_{S1} refers to the current through switch S₁).

The system 10, in accordance with the disclosed embodiments, requires fewer components and lower magnetic core volumes (i.e. smaller magnetic cores), when compared to other existing systems. The system 10 is therefore more compact, reliable, will cost less to manufacture, and offers superior performance, when compared to the other systems.

Although the subject matter has been described in language directed to specific environments, structural features and/or methodological acts, it is to be understood that the subject matter defined in the appended claims is not limited to the environments, specific features or acts described above as has been held by the courts. Rather, the environments, specific features and acts described above are disclosed as example forms of implementing the claims.

1. A laser excitation pulsing system, the system comprising:
a pulse transformer having a plurality of parallel connected primary windings and a secondary winding wound around a toroidal magnetic core in a coaxial fashion in which at least part of the primary windings are in the form of tubular sections through which corresponding parts of the secondary winding extend.

2. The system of claim 1, wherein the tubular sections of the primary winding include inner tubular parts and outer tubular parts and wherein the inner tubular parts are parallel spaced and circularly arranged about a central region.

3. The system of claim 2, wherein the outer tubular parts of the tubular sections of the primary winding are parallel spaced and radially arranged around the inner tubular parts thereof.

4. The system of claim 3, wherein the toroidal magnetic core is located between the inner and outer parts of the tubular sections of the primary winding.

5. The system of claim 1, further comprising:
a switching arrangement having a solid-state switch connected to one of the plurality of parallel connected primary windings of the pulse transformer.

6. The system of claim 5, wherein the solid-state switch is any one of: a thyristor, a metal-oxide-semiconductor field effect transistor, and an insulated-gate bipolar transistor switch.

7. The system of claim 6, wherein the solid state switch is the thyristor and wherein the thyristor is a gate turn-off thyristor.

8. The system of claim 7, further comprising: an LC circuit, arranged in an LC inversion topology, the LC circuit connected between the switch and the pulse transformer.

9. The system of claim 8, further comprising:
at least one magnetic pulse compression stage connected to the pulse transformer.

10. The system of claim 9, wherein a first of the at least one magnetic pulse compression stage is connected between the switch and the primary winding of the pulse transformer.

11. The system of claim 10, wherein the first magnetic pulse compression stage is connected between the LC inversion circuit and the primary winding of the pulse transformer.

12. The system of claim 10, further comprising: a second compression stage, wherein the second compression stage is connected to the secondary winding of the pulse transformer.

13. The system of claim 12, wherein the second compression stage is connected between the secondary winding of the pulse transformer and a discharge gap of a laser.

14. The system of claim 12, wherein the pulse transformer and the two magnetic compression stages each include a reset winding.

15. The system of claim 14, wherein the reset winding is in the form of a single turn winding which is configured to provide a reset signal for a magnetic core around which the turn winding is provided.

16. The system of claim 15, wherein the reset windings are connected in series with each other and are driven by a single reset power supply.

17. A laser, which includes the laser excitation pulsing system as claimed in claim 1.
